(19) United States
(12) Patent Application Publication
(10) Pub. No.: US 2026/0275930 A1
(43) Pub. Date: Sep. 17, 2026

(54) INTERNAL COMBUSTION ENGINE

(71) Applicant: INNIO Jenbacher GmbH & Co OG, Jenbach (AT)

(72) Inventors: Ingo Walch, Absam (AT); Johannes Huber, Kramsach (AT); Stefan Jakubek, Wien (AT); Martin Kozek, Wien (AT)

(21) Appl. No.: 19/472,614

(22) PCT Filed: Apr. 20, 2023
(86) PCT No.: PCT/AT2023/060134

§ 371 Date: Oct. 3, 2025

(51) Int. Cl. F02D 41/14; F02B 37/16; F02B 37/18; F02D 41/00

(52) U.S. Cl. CPC F02D 41/1454; F02B 37/16; F02B 37/18; F02D 41/0007; F02D 41/0077

(57) ABSTRACT

Internal combustion engine comprising an engine controller (2) configured to control a first control parameter and a second control parameter, characterised in that the engine controller (2) has stored a, preferably at least piecewise linear, control relationship (3) between the first control parameter and the second control parameter, and in that the engine controller (2) is configured to control the internal combustion engine (1) based on a distance (d) of an actual working point (4) of the internal combustion engine (1) from the control relationship (3), wherein the actual working point (4) comprises actual values of the first control parameter and the second control parameter.

### CROSS-REFERENCE TO RELATED APPLICATION

This application is a National Stage entry from, and claims benefit of, PCT Application No. PCT/AT2023/060134, filed on Apr. 20, 2023, entitled “INTERNAL COMBUSTION ENGINE”, which is herein incorporated by reference in its entirety.

### BACKGROUND

The present disclosure concerns an internal combustion engine with the features of a classifying portion, a method for operating an internal combustion engine according to the classifying portion, and a computer program product according to the classifying portion as described herein.

For example, regarding stationary or naval gas engines complex yet highly efficient control schemes are known in the prior art. Reference is for example made to EP 2977596 A1 or the unpublished European Patent Application EP22209889.9.

One aspect known in the prior art is, for instance, a control of emissions of an internal combustion engine using a boost pressure as substitute control variable in relation to the power or load of the internal combustion engine.

Another aspect appears in the context of smaller grids where the changes in load or power of the engine mechanically driving a generator may affect the grid frequency. Here, a so-called droop relationship between the power and the speed—or alternatively a generator frequency—is used to define a stable equilibrium point of the system for the given load, where the power of each contributing engine or other asset and the resulting grid frequency are clearly defined and stabilized.

Regardless of the concrete application of the modern internal combustion engine there are a large number of control variables which are interdependent. As mentioned, the available control schemes for internal combustion engines allow for quite precise control of the engine, nonetheless.

### BRIEF DESCRIPTION

An aspect of the disclosure is to provide an internal combustion engine, a method for operating an internal combustion engine, and a computer program product for operating an internal combustion engine which allow for an improvement of the quality of the control of an internal combustion engine.

Regarding the internal combustion engine, this aspect is achieved by the features described and claimed below, wherein the internal combustion engine comprises an engine controller configured to control a first control parameter and a second control parameter, and wherein the engine controller has stored a, preferably at least piecewise linear, control relationship between the first control parameter and the second control parameter, and wherein the engine controller is configured to control the internal combustion engine based on a distance of an actual working point of the internal combustion engine from the control relationship, wherein the actual working point comprises actual values of the first control parameter and the second control parameter.

Regarding the method, the aspect is achieved with the features described and claimed below, wherein the method comprises
controlling a first control parameter and a second control parameter,
using a, preferably at least piecewise linear, control relationship between the first control parameter and the second control parameter, and
controlling the internal combustion engine based on a distance of an actual working point of the internal combustion engine from the control relationship, wherein the actual working point comprises actual values of the first control parameter and the second control parameter.

Regarding the computer program product, the aspect is achieved by the features described and claimed below, wherein the computer program product comprises instruction which cause an executing computer to perform the following:
reading and/or loading and/or using a, preferably at least piecewise linear, control relationship between the first control parameter and the second control parameter, and
outputting control signals for controlling the internal combustion engine based on a distance of an actual working point of the internal combustion engine from the control relationship, wherein the actual working point comprises actual values of the first control parameter and the second control parameter.

Protection is additionally sought for a transitory or non-transitory data storage device having such a computer program product stored thereon.

A basic observation of certain embodiments of the disclosure is that between many of the plethora of control variables (from which the first control parameter and the second control parameter can be selected) used for controlling an internal combustion engine there often are—in many cases relatively simple—known or given relationships. As part of the disclosure, these relationships can be stored and/or exploited as control relationship as part of the control according to certain embodiments of the disclosure.

A basic aspect of the certain embodiments of the disclosure is that these relationships can be used to control the first control parameter and the second control parameter not each on their own. Rather, in a simple embodiment of the disclosure, the first control parameter and the second control parameter may be viewed as coordinates of an at least two-dimensional space in which both the control relationship and the working point—comprising the first control parameter and the second control parameter—of the internal combustion engine can be represented.

The inventors have observed that using the distance of the working point from the control relationship for the control of the first control parameter and the second control parameter a dramatically improved control of the internal combustion engine can be achieved. The underlying mechanism may be that the interdependence of the behaviour of the first control parameter and the second control parameter is automatically incorporated into the control of the internal combustion engine using embodiments of the disclosure.

In embodiments of the prior art often hard constraints based on the control relationships have been implemented in order to achieve a desired behaviour of the internal combustion engine. In particular, if model based or optimal controllers are used these hard constraints can be replaced by soft constraints giving the controller more intermediary states (i.e., at least a plane instead of just a line) to reach a desired state of the system.

The described embodiments can of course be extended towards a third or more control parameter(s).

The first control parameter, the second control parameter and/or the third or more control parameter(s) can themselves be one-dimensional or higher dimensional quantities.

The internal combustion engine according to certain embodiments of the disclosure can be stationary, naval, or otherwise industrial internal combustion engine.

They can use stoichiometric lambda or a lean burn concept.

They can preferably comprise an exhaust gas recirculation system.

The internal combustion engine can be a gas engine, configured to combust molecular hydrogen, natural gas, methane, or other gases with a significant hydrocarbon component, or mixtures of the mentioned gases.

The internal combustion engine can be mechanically coupled to a generator so as to drive the generator for producing electric energy from the mechanical energy delivered by the internal combustion engine.

Gas engines to which generators are coupled for generating electric energy are commonly called gensets.

The internal combustion engine can be of piston-cylinder type with a plurality of piston-cylinder units, preferably more than eight or ten.

The internal combustion engine according to certain embodiments of the disclosure can comprise at least one piston-cylinder unit (as mentioned), a charging system (e.g., a turbo charger, an electrically driven compressor, or mixed forms) with for example one, two, three, or four stages, and/or an exhaust gas aftertreatment system.

The control relationship can in preferred embodiments be a linear or piecewise linear relationship between the first control parameter and the second control parameter. The use of more complex control relationships is of course entirely possible.

The control relationship can for example be given as a graph or as a lookup table.

In preferred embodiments the control relationship is given by a desired working point comprising the first control parameter and the second control parameter together with a gradient which defines a linear relationship or a piece of a piecewise linear relationship.

In other preferred embodiments the control relationship can be given by two or more points where the control relationship is linear between nearest neighbour points, resulting in a linear or a piecewise linear control relationship. The points of the control relationship between the points can for example be found by interpolation.

In the context of certain embodiments of the disclosure, control of the internal combustion engine can be understood as the function of the engine controller, or the method step, or the output of the computer program product which sends signals to actuators of the internal combustion engine which influence the operation of the internal combustion engine, e.g., regarding its power output, boost pressure, emissions, fueling state, speed, lambda (air-fuel ratio), ignition timing, temperatures of the cylinder charge or the exhaust gas, engine knock and/or exhaust gas recirculation fraction.

Examples for such actuators would be one or more throttle valves, fuel mixers, fuel injectors, ignition devices, such as spark plugs, variable valve trains, compressor bypass valves, variable turbine geometry actuators, wastegate valves, exhaust gas recirculation valves, blow-off valves, and/or controllable heat exchangers.

The control according to certain embodiments of the disclosure can be open loop or closed loop.

Measurement values for feedback to closed loop controllers can for example be measurement values from one or more pressure sensors positioned and configured to measure a boost pressure and/or a cylinder charge pressure and/or a recirculated or exhausted exhaust gas pressure and/or an in cylinder pressure, engine speed sensors, temperature sensors positioned and/or configured to measure a cylinder charge temperature and/or an air temperature and/or a fuel temperature, and/or a recirculated or exhausted exhaust gas temperature, a lambda sensor, an NOx sensor and/or a knock sensor.

Further measurement values for the control can come from outside of the internal combustion engine, e.g., measurement values from an electrical grid, and/or from the generator coupled to the internal combustion engine.

The control of the internal combustion engine can be in the form of a cascaded control scheme, e.g., with high-level controllers controlling boost pressure, power output, load and/or emissions and the like, which output set values for lower-level controllers (see remaining examples above).

The low-level controls can be preferably implemented as open loop control or PID control (potentially with any of the PID gains zero). It furthermore can include models for feedforward or for open loop control that are possibly inverted.

Measures and/or features mentioned in connection with the prior art can also be implemented together with certain embodiments of the disclosure.

The engine controller of the internal combustion engine can be the executing computer for the computer program product.

The engine controller of the internal combustion engine and/or the executing computer for the computer program product can be arranged at the or close to the internal combustion engine. In other embodiments the engine controller and/or the executing computer for the computer program product can be implemented as a computer server with a—conceivably long distance—data and/or signal connection to the internal combustion engine.

The computer program product according to certain embodiments of the disclosure can be used to control a real internal combustion engine and/or for a simulated or model internal combustion engine.

It should be noted that the control according to certain embodiments of the disclosure can also be used in a higher level (micro) grid controller in order to steer the load split of different engines within a microgrid.

In such embodiments the first control parameter could be a control parameter of a first internal combustion engine and/or genset and the second control parameter could be a control parameter of a second internal combustion engine and/or genset. This concept can of course be extended to more than two internal combustion engines and/or gensets.

Consequently, protection is also sought for an arrangement comprising an internal combustion engine according to certain embodiments of the disclosure and at least one further internal combustion engine, wherein the first control parameter is a control parameter of the internal combustion engine, and the second control parameter is a control parameter of the at least one further internal combustion engine.

An operation of the internal combustion engine, in particular with a droop relationship as control relationship as described below, can therefore be especially beneficial for small, island, and/or micro grids (also called multi-engine operations) which require a load split control mechanism to avoid overloading or reverse power and keep the engines in a desired operation range.

Preferable embodiments of the disclosure are defined in the dependent claims.

The first control parameter can be an engine power and/or an engine load.

In the context of certain embodiments of the disclosure, the engine power (setpoint or actual) will at times just be referred to as the power.

The second control parameter can be a boost pressure and/or an engine speed and/or a generator frequency of a generator mechanically driven by the internal combustion engine.

In preferred embodiments the control relationship is a relationship between setpoints for the first control parameter and/or actual values for the first control parameter on the one hand and setpoints for the second control parameter and/or actual values for the second control parameter on the other hand.

In a particularly preferred embodiment, the first control parameter is an actual power of the internal combustion engine and/or the second control parameter is a boost pressure setpoint.

In such embodiments the boost pressure setpoint can be used as a substitute control variable for NOx emissions as suggested in EP 2977596 A which is incorporated into this application in its entirety and in particular regarding the particulars of the setup and calibration of the control relationship when the first control parameter is an actual power of the internal combustion engine, and the second control parameter is a boost pressure setpoint.

In such embodiments the control relationship can be such that the boost pressure setpoint are higher the higher the actual power is. In other word, in such embodiments the control relationship can be, preferably strictly, monotonically increasing.

It should be mentioned that further engine parameters can be made to have an influence on the control relationship, e.g., an exhaust gas temperature and/or an actual or set adjustment of a variable valve train.

In other particularly preferred embodiments the first control parameter can be a power setpoint (and/or power reference) and/or the actual power of the internal combustion engine and/or the second control parameter can be the speed setpoint of the internal combustion engine and/or frequency setpoint for the generator coupled to the internal combustion engine.

In such embodiments the control relationship could be called droop relationship.

Typically, the droop relationship is chosen such that the power (setpoint and/or actual) is lower if the engine speed or generator frequency is higher, and vice versa. In other word, in such embodiments the control relationship can be, preferably strictly, monotonically decreasing.

With this setup the internal combustion engine has a stabilising effect on the frequency and the load split between multiple generation assets for a given load in the grid.

The result of the droop mechanism is a stable equilibrium point of the system for the given load, where the power of each contributing engine or other asset and the resulting grid frequency are clearly defined.

This can be especially useful in smaller grids, such as an island grid, weak grid or micro grid, with less than 20, preferably less than 10 and particularly preferably less than 5, generators for creating electrical energy.

The mentioned power supply grid can however also be a public power supply grid.

In particularly preferred embodiments, the described techniques can be implemented two-fold (or even more), e.g., with a first control relationship, e.g., where the first control parameter is an actual power of the internal combustion engine and/or the second control parameter is a boost pressure setpoint, and a second control relationship, where the first control parameter can be a power setpoint (or power reference) and/or the actual power of the internal combustion engine and/or the second control parameter can be the speed setpoint of the internal combustion engine and/or frequency setpoint for the generator coupled to the internal combustion engine.

According to certain embodiments of the disclosure, the following can then be considered:
a first working point of the internal combustion engine comprising the actual power and the actual boost pressure
a second working point of the internal combustion engine comprising the actual power on the one hand and the actual engine speed and/or the actual generator frequency on the other hand
a first distance of the first working point from the first control relationship
a second distance of the second working point from the second control relationship

If the engine controller employs a cost function for control of the internal combustion engines (examples below), the cost function involving the first distance and the second distance (and so on) can be summed.

In preferred embodiments the engine power can be measured indirectly via electrical measurements on the generator coupled to the internal combustion engine.

In alternative or additional embodiments, the engine power can be estimated using other internal or external measurements.

Accordingly, the actual engine power can alternatively or additionally be estimated using measurements or set parameters of quantities comprising at least one of the following: lambda, boost pressure, charge temperature, exhaust gas temperature, time of ignition, throttle valve position, compressor bypass valve position, wastegate valve position, exhaust gas recirculation rate, fueling state, engine speed, generator frequency, load angle.

The first distance and the second distance can then be used joint and/or separately in various control elements of the control according to certain embodiments of the disclosure.

This can of course be generalised to more than two control relationships, working points, and distances, or with respect to one or more control relationships and working points in higher dimensions.

The engine controller can comprise open or closed loop controllers for at least one engine parameter and/or at least one actuator, and the engine controller can be configured to control the internal combustion engine by setting setpoints for the open or closed loop controllers.

The engine controller can comprise a model-based controller for controlling the internal combustion engine.

The engine controller is configured to set the setpoints directly based on the distance of the actual working point of the internal combustion engine from the control relationship, preferably employing the model-based controller.

The model-based controller can preferably be a model predictive controller and/or a state space controller, preferably for performing the at least one high-level control, preferably during a load transient operation and/or substantially during all operation.

Instead of a model predictive controller and/or a state space controller the model-based controller can be another controller configured to output the at least one setpoint for the at least one low-level controller by solving a mathematical optimization problem based on actual measurements and a dynamic engine model to minimize the control error.

The model-based controller can comprise a cost function to be minimised.

A model employed by the model-based controller can particularly preferably be a model of the internal combustion engine, potentially together with a generator coupled to the internal combustion engine and/or a power supply grid and/or participants of the power supply grids, such as other generators for creating electrical energy or loads.

In particular, the model-based controller can be configured for solving an optimization problem that makes use of a dynamic engine model to predict the evolution of relevant engine variables (e.g., speed, boost pressure, power, torque, lambda, EGR concentration) over a finite or infinite prediction horizon in response to the selected setpoints to the low level controllers and therefore is able to coordinate the setpoints in a preferably optimal way (e.g. linear quadratic regulator, model predictive controller). The model could be thought of as a constraint on the optimisation problem.

In preferred embodiments of the disclosure, the evolution of the relevant engine variables can be used in a cost function involving the distance of the working point from the control relationship, preferably in a quadratic manner.

The model-based controller can apply nonlinear control techniques such as nonlinear model predictive control, feedback linearization or backstepping, or linear control techniques that work with a model that is linearized around the actual/reference operation point or around the actual/reference trajectory of state/system variables.

The controller may receive measurements of power that provide feedforward of a measured disturbance that is responsible for a fast reaction of the low-level control in case of a load transient. A feedback control based on the speed and boost pressure and/or other measurements can provide the additional control action for stabilizing the system at the desired references.

The basis for the model-based controller is preferably a dynamic engine model that describes the evolution of relevant engine variables (speed, boost pressure, air fuel ratio, torque and/or power and possibly others) depending on the control inputs and external disturbances such as electrical loads on the generator that is coupled to the engine.

An example for such a model is provided by J. Huber, H. Kopecek, and M. Hofbaur. In “Nonlinear model predictive control of an internal combustion engine exposed to measured disturbances”, Control Engineering Practice 44, (2015) for the lean burn case without exhaust gas recirculation or as a minimum formulation given by the following equations including EGR.

A torque balance between engine torque τₑ and generator load τ_{g} governs the engine speed is given by Guzzella, Lino, and Christopher Onder in “Introduction to modeling and control of internal combustion engine systems”, Springer Science & Business Media, (2009) as

$${\dot{ω}}_{e} = \frac{1}{{J}_{e}} ( {τ}_{e} - {τ}_{g} )$$

with the engine torque τₑ computed as depending on volumetric efficiency ηᵥₒₗ, brake efficiency η_{brake}, displacement volume V_{d}, lower heating value Hᵢ, gas constant of the mixture Rᵢₘ, intake manifold temperature Tᵢₘ, stoichiometric air fuel ratio Lₘᵢₙ, as well as the controlled variables engine speed omega, intake manifold pressure pᵢₘ, air fuel equivalence ratio λ and the exhaust gas recirculation fraction c_{egr}, leading to

$${\dot{ω}}_{e} = \frac{1}{{J}_{e}} ( {K}_{e} ( {p}_{im} , {T}_{im} , λ , IT , {ω}_{e} ) \frac{1 - {c}_{egr}}{1 + λ {L}_{min}} {p}_{im} - \frac{{P}_{g}}{{ω}_{e}} )$$

with

$${K}_{e} ( {p}_{im} , {T}_{im} , λ , IT , {ω}_{e} ) = \frac{{V}_{d} {H}_{i} {η}_{vol} ( {p}_{im} , {T}_{im} , {ω}_{e} ) {η}_{brake} ( {p}_{im} , {T}_{im} , λ , IT , {ω}_{e} )}{4 π {R}_{im} {T}_{im}}$$

The following assumptions for the closed loop control of the at least one low level control may be taken for the design of the at least one high-level control.

The tracking behaviour of boost pressure, with boost pressure reference

$${p}_{im}^{sp} ≡ {u}_{p}$$

and measurement pᵢₘ can be modelled with time constant T and slope κ with (see FIG. 6)

$${\dot{p}}_{im} = \{ \begin{matrix}κ ( {p}_{im} , ω , {u}_{it} ) & if {u}_{p} > {p}_{im} \\ \frac{1}{T} ( {u}_{p} - {p}_{im} ) & else\end{matrix} .$$

Or further simplified, e.g.,

$${\dot{p}}_{im} = \frac{1}{T} ( {u}_{p} - {p}_{im} ) .$$

The tracking behaviour of air fuel equivalence ratio λ can be modelled with a dependence on the delay between the gas dosage and the cylinders D as well as a mixing time constant T_{λ} with

$$\dot{λ} = \frac{1}{{T}_{λ}} ( {u}_{λ} ( t - D ) - λ )$$

The tracking behavior of exhaust gas recirculation concentration c_{egr} can be modelled with a dependence on the transport delay between the EGR valve and the cylinders D_{egr} as well as a mixing time constant T_{egr},

$${\dot{c}}_{egr} = \frac{1}{{T}_{egr}} ( {u}_{egr} ( t - {D}_{egr} ) - {c}_{egr} )$$

There may be many sources of uncertainties for these models. The applied gas type can change, with uncertainty in its actual composition and the related lower heating value Hᵢ and stoichiometric air fuel equivalence ratio Lₘᵢₙ. On the other hand, the engine setup itself may be quite uncertain, with a large number of possible manufacturing variants characterized for example by different compression ratios, turbocharger layouts and piston types influencing the volumetric and brake efficiencies ηᵥₒₗ and η_{brake}. Furthermore, application specific parameterization of ignition timing, cooler temperatures etc. influence the same quantities. Of course, also aging and service actions that influence the static and dynamic behavior of the engine can introduce another source of uncertainty.

The engine controller can preferably be configured to set the setpoints indirectly through superposed controllers by setting setpoints of the superposed controllers based on the distance of the actual working point of the internal combustion engine from the control relationship, wherein the engine controller is configured to
use an output of the superposed controllers as the setpoints for the open or closed loop controllers and/or
control the first control parameter and/or the second control parameter by means of the superposed controllers.

The open or closed loop controllers can comprise
a boost pressure control, an air-fuel-ratio control and/or an exhaust gas recirculation fraction control and/or
a compressor bypass valve control, throttle valve control, a wastegate valve control, a fuel dosage valve control and/or an exhaust gas recirculation valve control.

The engine controller can be configured to closed loop control the boost pressure and/or the engine speed and/or the generator frequency, wherein the actual boost pressure and/or the actual engine speed and/or the actual generator frequency are preferably measured directly.

The engine controller can be configured to control the internal combustion engine based on the distance of the actual working point from the control relationship such that a given value of the distance of the actual working point from the control relationship is decreased, preferably minimised.

The engine controller can be configured to control the internal combustion engine based on a minimisation or maximisation of a cost function which is dependent on the distance of the actual working point of the internal combustion engine from the control relationship, wherein the cost function is preferably minimised or maximised where the distance is zero.

The cost function can preferably depend quadratically on the distance of the actual working point to the control relationship.

The distance can be a normal distance from the actual working point of the internal combustion engine to the control relationship.

The engine controller can be configured to shift the control relationship based on at least one desired value for the first control parameter and/or the second control parameter.

In some embodiments of the disclosure, the control relationship can be static or unchanged over the time of the operation of the internal combustion engine.

In other embodiments the control relationship can be dynamically adjusted, e.g., as mentioned based on a desired value for the first control parameter and/or the second control parameter.

Additionally, mixed embodiments are conceivable where the control relationship is static for certain amounts of time and is adjusted and/or shifted at points in time or during time periods which are predetermined or dynamically set.

The control relationship can be stored in the engine controller at least as a gradient and/or slope of the at least piecewise linear relationship, preferably together with the at least one desired value for the first control parameter and/or the second control parameter.

Preferred measurement values which can be taken at the internal combustion engine and/or the generator and which can be used in any of the controls of the cascaded control according to certain embodiments of the disclosure as feedback are for example:
engine speed and/or equivalent grid frequency and/or
generator power and/or crankshaft torque and/or
generator voltage and/or
boost pressure before and/or after the throttle valve and/or
boost temperature (i.e., the temperature of the air and/or air/fuel mixture downstream of a compressor).

The engine controller can be configured to
receive a stationary boost pressure reference and/or compute the stationary boost pressure reference resulting from the, preferably piecewise linear, control relationship between the power and the boost pressure, and
calculate the at least one setpoint, preferably the fraction or amount of recirculated exhaust gas and/or the air/fuel ratio and/or the air/fuel equivalence ratio, in dependence on the stationary boost pressure reference.

### BRIEF DESCRIPTION OF THE DRAWINGS

Further details and advantages of certain embodiments of the disclosure are apparent from the figures and the accompanying description of the figures. The figures show:

FIG. 1 a diagram of an embodiment of a control relationship and an actual working point of an internal combustion engine,

FIG. 2 a comparison diagram comparing a control according to the prior art with a control according to certain embodiments of the disclosure,

FIG. 3 a diagram of a further embodiment of a control relationship and an actual working point of an internal combustion engine,

FIGS. 4 and 5 schematic depictions of embodiments of an internal combustion engine according to certain embodiments of the disclosure,

FIG. 6 a schematic depiction of a genset, and

FIG. 7 a schematic depiction of an embodiment of a cascaded control according to certain embodiments of the disclosure.

### DETAILED DESCRIPTION

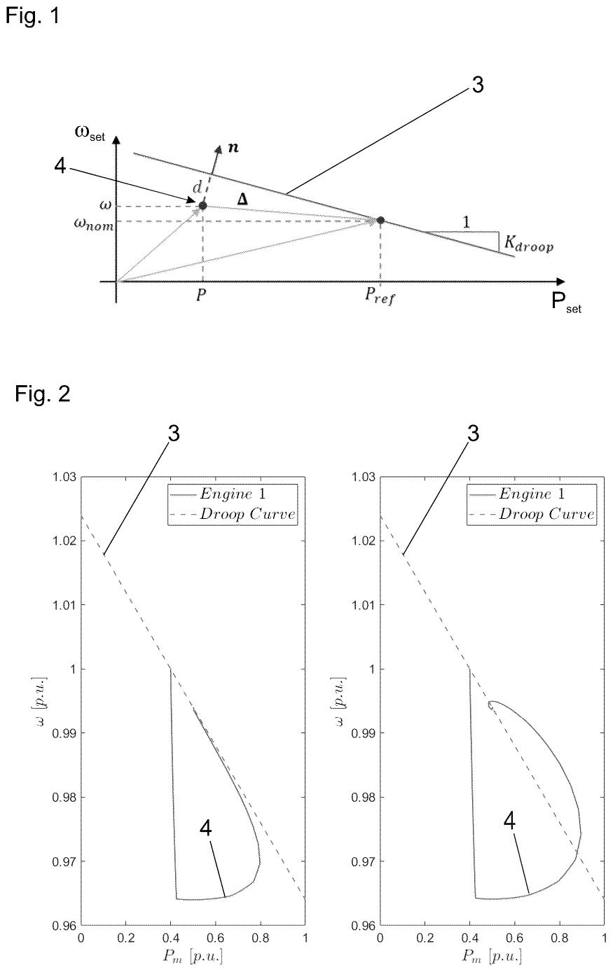

FIG. 1 shows a diagram of an embodiment of a control relationship 3 and an actual working point 4 of an internal combustion engine 1.

In this case the control relationship 3 is a linear relationship between a power setpoint Pₛₑₜ (and/or power reference and/or the actual power) of the internal combustion engine 1 as the first control parameter and a speed setpoint wₛₑₜ of the internal combustion engine 1 (and/or frequency setpoint for the generator coupled to the internal combustion engine 1) as the second control parameter (droop relationship).

The linear control relationship 3 is in this case given by a power reference Pref, a engine speed reference wₙₒₘ, and a gradient K_{droop} (or K_{d} for short).

This makes it possible to shift the control relationship 3 by simply moving the power reference Pref and/or the engine speed reference wₙₒₘ.

The actual working point 4 of the internal combustion engine 1 comprises an actual power P and an actual engine speed w.

The normal distance d of the actual working point 4 from the control relationship 3 can be expressed as follows:

$$d = {n}^{T} Δ = - \frac{1}{\sqrt{{K}_{droop}^{2} + 1}} ( Δ P * {K}_{droop} + Δω )$$

Here, DP=Pref−P and Dw=wnom−w. A cost function which the engine controller 2 minimises for controlling the internal combustion engine can be essentially quadratic in d. In term of DP and Dw the cost function can be expressed as

$${J}_{d} = {q}_{d} * {d}^{2} = {q}_{d} ( Δ {P}^{2} {K}_{droop}^{2} + {Δω}^{2} + 2 Δ P Δω {K}_{droop} ) .$$

The factor q_{d} can be used as a weight in case there are other terms in a total cost function of the model predictive controller.

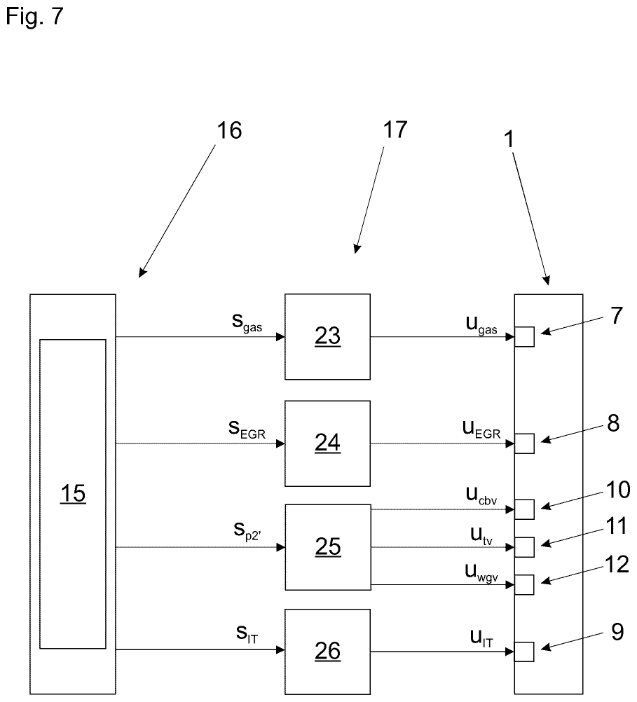

In the present embodiment it is envisaged that model predictive controller as described before can be used to minimise this cost function in order to find optimal control inputs (here setpoints for low-level controllers 17, cf. FIG. 7) for the internal combustion engine 1.

FIG. 2 is a comparison diagram for a control according to certain embodiments of the disclosure (left) and a control according to the prior art (right).

Depicted is the control relationship 3 (droop relationship, dashed) in a speed-power-diagram and a trajectory of the actual working point 4 of the internal combustion engine as determined in a simulation (solid line).

The actual working point 4 was subjected to a disturbance (nearly vertical line) resulting in a working point distanced from the control relationship 3 and subsequently the engine behaviour can be read from the respective trajectory of the working point 4.

As is apparent, the trajectory on the left according to certain embodiments of the disclosure returns to the control relationship 3 much faster than the trajectory on the right with the control according to the prior art.

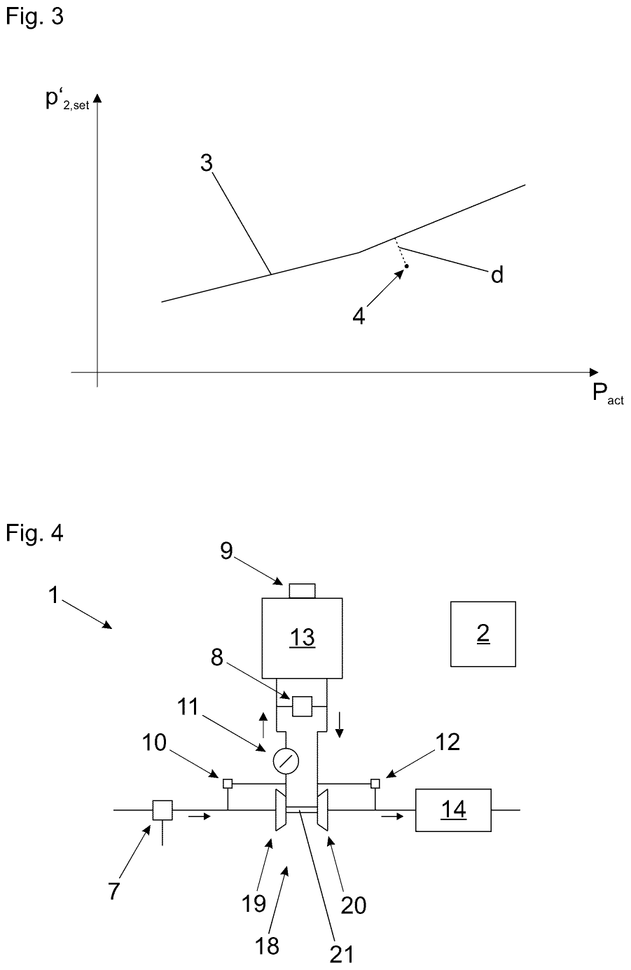

FIG. 3 shows a further embodiment of a control relationship according to certain embodiments of the disclosure. Depicted is a piecewise linear control relationship 3 between an actual power output P_{act} of the internal combustion engine 1 and a boost pressure setpoint p′₂. As mentioned before, such a control relationship 3 can be employed to use the boost pressure as a substitute control parameter for NOx emissions.

The (normal) distance d of the actual working point 4 of the internal combustion engine 1 can be computed and used in a, for example quadratic, cost function in analogy to what was described in connection with FIG. 1.

The embodiments of FIGS. 1 and 3 can be used separately or in combination. Where a combination is envisaged the cost function arising from the control relationship 3 according to FIG. 1 and FIG. 3 can be summed up.

As mentioned before such a “global” cost function could then be minimised using a model predictive controller to find optimal control inputs for the internal combustion engine.

FIG. 4 shows a schematic depiction of an embodiment of an internal combustion engine 1 according to certain embodiments of the disclosure.

A gas dosage valve 7 is provided for mixing a fuel and air to produce a combustible air/fuel mixture.

The fuel can for example be natural gas including methane and/or molecular hydrogen. Alternatively, or additionally the fuel may comprise other hydrocarbons.

The air/fuel mixture is compressed in compressor 19 of the turbocharger 18 so that the air/fuel mixture is charged into a piston-cylinder unit 13 or a plurality of piston-cylinder units 13 while under a boost pressure p₂′ (potentially together with recirculated exhaust gas, see below).

In a bypass conduct bypassing the compressor 19 of the turbocharger 18 there is a compressor bypass valve 10 which can be used to direct an amount of the air/fuel mixture around the compressor 19 so as to lower the boost pressure p₂′.

In the conduct connecting the compressor 19 of the turbocharger 18 to the piston-cylinder unit(s) 13 there is a throttle valve 11.

In this embodiment the engine is mixture charged as the gas dosage valve 7 is upstream of the compressor 19. In other embodiments the gas dosage valve 7 can be arranged downstream of the compressor 19 (air charged engine).

The turbocharger 18 in this example is a single stage turbocharger 18. In other embodiments according to the disclosure, there can two, three, four or more turbocharger 18 stages.

The internal combustion engine 1 could also include a blowoff valve for rapidly discharging charged air and/or charged air/fuel mixture into the environment or other separate volumes. However, in this embodiment such a blowoff valve is not included.

The cylinder charge, which is the air/fuel mixture charged into the piston-cylinder unit(s) 13 under the boost pressure p₂′ is ignited using an ignition device 9, in this case a system comprising a spark plug for each piston-cylinder unit 13.

In principle, certain embodiments of the disclosure can also be used with compression ignition engines and/or engines operated with liquid fuel and/or dual fuel engines.

The piston-cylinder unit 13 can comprise a pre-combustion chamber.

After combustion in the piston-cylinder unit(s) 13 the exhaust gases remaining in the cylinder are expelled therefrom.

There is an exhaust gas recirculation passage in which an exhaust gas recirculation valve 8 is arranged.

The exhaust gas recirculation valve 8 can be used to recirculate part of the exhaust gas into the mass flow of the air/fuel mixture directed into the piston-cylinder unit 13, such that the cylinder charge comprises recirculated exhaust gas next to the air/fuel mixture.

The exhaust gas which is not recirculated is decompressed in the exhaust turbine 20 of the turbocharger 18. The exhaust turbine 20 drives the turbocharger shaft 21 which in turn drives the compressor 19 of the turbocharger 18.

Alternatively, or additionally to the exhaust turbine 20 the charging system can comprise an electric drive for the compressor 19 of the turbocharger 18.

There is a bypass conduct bypassing the exhaust turbine 20 and a waste gate valve 12 is arranged in this bypass of the exhaust turbine 20 so that part of the exhaust gas can be routed past the exhaust turbine 20.

The exhaust gas passing through the exhaust turbine 20 and/or the wastegate valve 12 is then subjected to aftertreatment in the exhaust gas aftertreatment system 14 which can comprise different kinds of catalytic converters.

For example, if the internal combustion engine 1 is operated with essentially stoichiometric lambda the exhaust gas aftertreatment system 14 can comprise a three-way catalytic converter.

In other embodiments where the internal combustion engine 1 is operated with a lean burn concept the exhaust gas aftertreatment system 14 can comprise a selective catalytic reaction catalytic converter and/or an oxidation catalytic converter and/or a thermal oxidiser.

In embodiments where the internal combustion engine 1 is operated with a lean burn concept the exhaust gas recirculation valve 8 and the corresponding conduct may not be present.

In embodiments where the internal combustion engine can be operated both stoichiometrically and with a lean burn concept as desired the exhaust gas recirculation valve 8 can preferably be kept closed as long as the internal combustion engine 1 is operated at lambda greater than one (lean operation).

The engine controller 2 is in signal communication with the actuators of the internal combustion engines, which in this embodiment comprise the gas dosage valve 7, the exhaust gas recirculation valve 8, the at least one ignition device 9, the compressor bypass valve 10, the throttle valve 11, and the wastegate valve 12.

However, the signal communication of the engine control 2 with the actuators is not depicted in FIG. 1 for the sake of clarity the figure.

An embodiment for controlling the internal combustion engine 1 is described in connection with FIG. 3.

The control 2 of this embodiment is also in signal communication with a multitude of measurement devices which can be used to implement closed loop control, both for the high-level control 3 and the low-level control 3.

Measurement device which can for example be used in this capacity are
pressure sensors, upstream and/or downstream of the compressor 19 and/or upstream and/or downstream of the exhaust turbine 20, and/or
temperature sensors, upstream and/or downstream of the compressor 19 and/or upstream and/or downstream of the exhaust turbine 20, and/or
in cylinder pressure sensors and/or
knock sensors and/or
lambda sensors in the exhaust gas conduct and/or
oxygen concentration sensors and/or
engine speed sensors

These sensors can be embodied as in principle known in the prior art.

Also here, the signal communication of the engine controller 2 with the sensors is not depicted in FIG. 4 for the sake of clarity of the figure.

In the embodiment of FIG. 4 the exhaust gas recirculation valve 8 recirculates exhaust gas from upstream of the turbine 20 to a volume downstream of the compressor 19 when at least partially opened. This is called high-pressure exhaust gas recirculation.

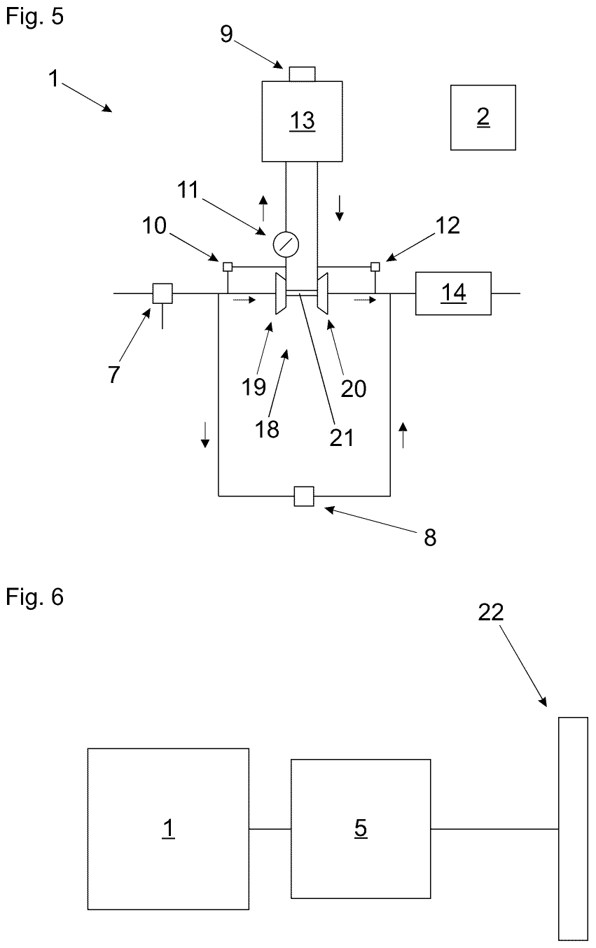

FIG. 5 shows an embodiment where the exhaust gas is recirculated from downstream of the turbine 20 to upstream of the compressor 19, i.e., a low-pressure exhaust gas recirculation.

FIG. 6 schematically shows a genset with an internal combustion engine 1 according to certain embodiments of the disclosure, which is coupled mechanically to a generator 5 for creating electrical energy.

The generator 5 may be connected to a power supply grid 22. The power supply grid can for example be a public power supply grid, an island grind, or a microgrid.

In these embodiments the engine controller 2 may also receive measurement values from the generator 5 and/or power supply grid 22, such as a frequency w or voltage or current.

FIG. 7 shows schematically a cascaded control scheme for operating an internal combustion engine 1 according to the embodiment of FIG. 4 or 5.

It comprises a high-level control 16 and number of low-level controls 17. The low-level controls 17 receive setpoints from the high-level control 16 and output command values to the actuators 7 to 12 of the internal combustion engine 1.

The high-level control 16 may receive reference values, e.g., for engine speed (or generator frequency) and/or boost pressure and/or droop setpoints and/or droop offsets.

Through setting of the, preferably piecewise linear, control relationship 3 between the power and the boost pressure reference, a stationary boost pressure reference at a given load is provided and as a result a desired working point of the internal combustion engine 1 regarding emissions on the one hand and combustion stability on the other hand is defined (see in this context also EP 2977596 A1). It serves as basis for the calculation of the setpoints given to the low-level controls 17.

It should be mentioned that the stationary boost pressure reference resulting from the, preferably piecewise linear, control relationship between the power and the boost pressure, and the boost pressure setpoint sₚ₂′ mentioned below are different elements of the cascaded control of this embodiment. The stationary boost pressure reference serves as a reference to define the desired operation point proportional to the load and usually does not change during stationary operation of the internal combustion engine. The boost pressure setpoint sₚ₂′ can change dynamically to support the speed and power control of the engine during transients and to stabilize the engine at the desired operation point defined by speed and boost pressure reference.

The high-level control 16 in this embodiment includes a model-based controller 15, here an in and of itself known LQR controller.

The at least one high-level control 16 is configured to control a power output and a speed and a boost pressure of the internal combustion engine 1 by directly generating setpoints for the low-level controllers 17.

For this the model-based controller 15 comprises an appropriate cost function which, as mentioned before, is quadratic in the distance d of the actual working point 4 of the internal combustion engine 1 from the control relationship 3.

Based on the measurements and the minimisation of the cost function the high-level control 16 computes setpoints for gas dosage, EGR mass flow, boost pressure and ignition timing.

The gas dosage setpoint s_{gas} is given to the gas dosage control 23. Based on the gas dosage setpoint s_{gas} the gas dosage control outputs a gas dosage command value u_{gas} to the gas dosage valve 7 of the internal combustion engine 1.

The recirculated exhaust gas setpoint s_{EGR} is given to the EGR control 24. Based on the recirculated exhaust gas setpoint s_{EGR} the EGR control 24 outputs a recirculated exhaust gas command value u_{EGR} to the exhaust gas recirculation valve 8 of the internal combustion engine 1.

The gas dosage setpoint s_{gas} in this embodiment is given as a lambda setpoint but could in principle also be given as a mass flow parameter.

The recirculated exhaust gas setpoint s_{EGR} in this embodiment is given as mass flow parameter but can for example are be given relative to the mass flow of air and/or air fuel mixture in the intake manifold (fraction).

The boost pressure setpoint sₚ₂′ is given to the boost pressure control 25. Based on the boost pressure setpoint sₚ₂′ the boost pressure control outputs a compressor bypass valve command value U_{cbv} to the compressor bypass valve 10 of the internal combustion engine 1, a throttle valve command value uₜᵥ to the throttle valve 11 of the internal combustion engine 1, and wastegate valve command value u_{wgv} to the wastegate valve 12 of the internal combustion engine 1.

The ignition timing setpoint s_{IT} is given to the ignition timing control 26. Based on the ignition timing setpoint s_{IT} the ignition timing control 26 outputs an ignition timing command value u_{ΓΓ} to the ignition device 9, in this embodiment a system comprising a spark plug for each piston-cylinder unit 13, of the internal combustion engine 1.

The gas dosage control 23, the EGR control 24, the boost pressure control 25, and the ignition timing control 26 are low-level controls 17 in the sense of certain embodiments of the disclosure.

The gas dosage control 23, the EGR control 24, and/or the ignition control 26 can be open loop controllers.

The boost pressure controller 25 can be a closed loop controller with a measured boost pressure as a feedback parameter.

The gas dosage control can be a closed loop control with measured lambda or oxygen fraction in the exhaust as a feedback parameter.

The modules (at least reference numerals 15 and 23 to 28) can be implemented as hardware modules in reality. However, in preferred embodiments of the disclosure, these modules are implemented as software modules being executed on the engine controller 2. Mixed implementations are of course also conceivable.

### LIST OF REFERENCE SIGNS

1 Internal combustion engine
2 engine controller
3 control relationship
4 actual working point
5 generator
6
7 gas dosage valve
8 exhaust gas recirculation valve
9 ignition device
10 compressor bypass valve
11 throttle valve
12 wastegate valve
13 piston-cylinder unit
14 exhaust gas aftertreatment system
15 model-based controller
16 high-level control X
17 low-level control X
18 turbocharger
19 compressor
20 exhaust turbine
21 turbocharger shaft
22 power supply grid
23 gas dosage control
24 EGR control
25 boost pressure control
26 ignition timing control
d distance from the actual working point to the control relationship
s_{gas} gas dosage setpoint
s_{EGR} recirculated exhaust gas setpoint
s_{P2}′ boost pressure setpoint
s_{IT} ignition timing setpoint
u_{gas} ignition timing command value
u_{EGR} recirculated exhaust gas command value
u_{cbv} compressor bypass valve command value
uₜᵥ throttle valve command value
u_{wgv} wastegate valve command value
u_{ΓΓ} ignition timing command value

1. A system, comprising:
an engine controller of an internal combustion engine, wherein the engine controller is configured to control a first control parameter and a second control parameter, wherein the engine controller has stored a control relationship between the first control parameter and the second control parameter, the engine controller is configured to control the internal combustion engine based on a distance of an actual working point of the internal combustion engine from the control relationship, and the actual working point comprises actual values of the first control parameter and the second control parameter.

2. The system of claim 1, wherein the control relationship is an at least piecewise linear control relationship.

3. The system of claim 1, wherein the first control parameter is an engine power and/or an engine load, wherein the second control parameter is a boost pressure and/or an engine speed and/or a generator frequency of a generator mechanically driven by the internal combustion engine.

4. The system of claim 1, wherein the control relationship is a relationship between setpoints for the first control parameter and/or actual values for the first control parameter on the one hand and setpoints for the second control parameter and/or actual values for the second control parameter on the other hand.

5. The system of claim 1, wherein the engine controller comprises open or closed loop controllers for at least one engine parameter and/or at least one actuator, and the engine controller is configured to control the internal combustion engine by setting setpoints for the open or closed loop controllers.

6. The system of claim 5, wherein the engine controller is configured to set the setpoints directly based on the distance of the actual working point of the internal combustion engine from the control relationship.

7. The system of claim 5, wherein the engine controller is configured to set the setpoints indirectly through superposed controllers by setting setpoints of the superposed controllers based on the distance of the actual working point of the internal combustion engine from the control relationship, wherein the engine controller is configured to
use an output of the superposed controllers as the setpoints for the open or closed loop controllers; and/or
control the first control parameter and/or the second control parameter via the superposed controllers.

8. The system of claim 5, wherein the open or closed loop controllers comprise:
a boost pressure control, an air-fuel-ratio control, and/or an exhaust gas recirculation fraction control; and/or
a compressor bypass valve control, a throttle valve control, a wastegate valve control, a fuel dosage valve control, and/or an exhaust gas recirculation valve control.

9. The system of claim 8, wherein the engine controller is configured to closed loop control the boost pressure and/or the engine speed and/or the generator frequency, wherein the actual boost pressure and/or the actual engine speed and/or the actual generator frequency are measured directly.

10. The system of claim 1, wherein the engine controller is configured to control the internal combustion engine based on the distance of the actual working point from the control relationship such that a given value of the distance of the actual working point from the control relationship is decreased or minimised.

11. The system of claim 1, wherein the engine controller is configured to control the internal combustion engine based on a minimisation or maximisation of a cost function which is dependent on the distance of the actual working point of the internal combustion engine from the control relationship, wherein the cost function is minimised or maximised where the distance is zero.

12. The system of claim 11, wherein the cost function depends quadratically on the distance of the actual working point to the control relationship.

13. The system of claim 1, comprising the internal combustion engine having one or more piston-cylinder assemblies, each having a piston that reciprocates in a respective piston.

14. The system of claim 1, wherein the distance is a normal distance from the actual working point of the internal combustion engine to the control relationship.

15. The system of claim 1, wherein the engine controller is configured to shift the control relationship based on at least one desired value for the first control parameter and/or the second control parameter.

16. The system of claim 15, wherein the control relationship is stored in the engine controller at least as a gradient and/or slope of the control relationship, together with the at least one desired value for the first control parameter and/or the second control parameter, wherein the control relationship comprises an at least piecewise linear control relationship.

17. The system of claim 1, comprising:
the internal combustion engine; and
at least one further internal combustion engine, wherein the first control parameter is a control parameter of the internal combustion engine, and the second control parameter is a control parameter of the at least one further internal combustion engine.

18. A method for operating an internal combustion engine, comprising:
controlling a first control parameter and a second control parameter;
using a control relationship between the first control parameter and the second control parameter; and
controlling the internal combustion engine based on a distance of an actual working point of the internal combustion engine from the control relationship, wherein the actual working point comprises actual values of the first control parameter and the second control parameter.

19. A tangible non-transitory computer-readable media, comprising processor-executable instructions that, when executed by one or more processors, cause the one or more processors to perform operations comprising:
controlling a first control parameter and a second control parameter;
reading and/or loading and/or using a control relationship between the first control parameter and the second control parameter; and
outputting control signals for controlling the internal combustion engine based on a distance of an actual working point of the internal combustion engine from the control relationship, wherein the actual working point comprises actual values of the first control parameter and the second control parameter.

20. The media of claim 19, wherein the control relationship is an at least piecewise linear control relationship.
